(19) United States
(12) Patent Application Publication
(10) Pub. No.: US 2026/0269511 A1
(43) Pub. Date: Sep. 10, 2026

(54) SOCKET

(71) Applicant: Anker Innovations Technology Co., Ltd., CHANGSHA (CN)

(72) Inventors: Xianjie TANG, SHENZHEN (CN); Tao CHEN, SHENZHEN (CN)

(73) Assignee: Anker Innovations Technology Co., Ltd., CHANGSHA (CN)

(21) Appl. No.: 19/657,902

(22) Filed: Apr. 24, 2026

Related U.S. Application Data
(63) Continuation of application No. PCT/CN2024/105029, filed on Jul. 11, 2024.

(30) Foreign Application Priority Data
Oct. 30, 2023 (CN) 202322927583.X

(51) Int. Cl. H01R 13/447

(52) U.S. Cl. CPC H01R 13/447

(57) ABSTRACT

The present disclosure provides a socket, including a socket body, a hole member, and a linkage mechanism. The hole member defines an insertion hole and is disposed on the socket body vertically movable relative thereto. The linkage mechanism includes a safety door movably disposed on the socket body and linked with the hole member. The safety door is configured to be pushed by a plug electrode to move from a first position toward a second position, simultaneously driving the hole member to rise along an insertion direction of the plug electrode. When the safety door is at the first position, the safety door at least partially blocks an electrode member. When the safety door is at the second position, the safety door exposes the electrode member through the insertion hole. The dual-function safety door enables a compact socket profile while preventing accidental contact with the electrode member.

### CROSS-REFERENCE TO RELATED APPLICATIONS

This application is a continuation of International Patent Application No. PCT/CN2024/105029, filed on Jul. 11, 2024, which claims priority to Chinese Patent Application No. 202322927583.X, filed on Oct. 30, 2023, the contents of each of which are herein incorporated by reference in their entireties.

### TECHNICAL FIELD

The present disclosure relates to the field of socket technology, and in particular to a socket.

### BACKGROUND

Sockets are commonly used electrical appliances in daily life, and are generally used in conjunction with plugs. The sockets may also be referred to as power sockets, switched outlets, power strips, outlet strips, or extension cords.

However, most existing sockets have a problem of being relatively large in volume and not being sufficiently thin and compact.

### SUMMARY

Some embodiments of the present disclosure may provide a socket. The socket may include a socket body, a hole member, and a linkage mechanism. The socket body may include an electrode member. The hole member may define an insertion hole and may be disposed on the socket body so as to be vertically movable relative thereto. The linkage mechanism may be disposed on the socket body and linked with the hole member. The linkage mechanism may include a safety door. The safety door may be movably disposed on the socket body and may be linked with the hole member. The safety door may be movable between a first position and a second position. The safety door may be configured to be pushed by a plug electrode during insertion of the plug electrode to move from the first position toward the second position, further driving the hole member to rise relative to the socket body along an insertion direction of the plug electrode. When the safety door is at the first position, the safety door may be configured to at least partially block the electrode member. When the safety door is at the second position, the safety door may be configured to expose the electrode member through the insertion hole.

### BRIEF DESCRIPTION OF THE DRAWINGS

FIG. 1 is an exploded schematic view of a socket according to some embodiments of the present disclosure.

FIG. 2 is a schematic view of the socket in a storage state and a protruding state according to some embodiments of the present disclosure.

FIG. 3 is a schematic structural view of a linkage mechanism disposed on a socket body according to some embodiments of the present disclosure.

FIG. 4 is a schematic structural view of a linkage mechanism disposed on a fixing frame according to some embodiments of the present disclosure.

FIG. 5 is a schematic structural view of a fixing frame according to some embodiments of the present disclosure.

FIG. 6 is a schematic structural view of a hole member according to some embodiments of the present disclosure.

FIG. 7 is a schematic structural view of a hole member, a linkage mechanism, and a fixing frame assembled together according to some embodiments of the present disclosure.

FIG. 8 is a schematic view of a working principle of a linkage mechanism according to some embodiments of the present disclosure.

FIG. 9 is a schematic structural view of a hole member, a linkage mechanism, and a fixing frame assembled together according to some other embodiments of the present disclosure.

FIG. 10 is a schematic structural view of a linkage mechanism disposed on a fixing frame according to some other embodiments of the present disclosure.

FIG. 11 is a schematic structural view of a fixing frame according to some other embodiments of the present disclosure.

FIG. 12 is a schematic structural view of a hole member according to some other embodiments of the present disclosure.

FIG. 13 is a schematic cross-sectional view taken along line A-A in FIG. 4.

### DETAILED DESCRIPTION

Some embodiments of the present disclosure will be clearly and completely described below with reference to the accompanying drawings of the embodiments of the present disclosure. The described embodiments may only be some embodiments of the present disclosure, rather than all embodiments. Based on the embodiments of the present disclosure, all other embodiments that may be obtained by a person of ordinary skill in the art without undue experimentation shall fall within the scope of the present disclosure.

Furthermore, it is to be understood that the use of the term “substantially” herein, unless otherwise defined with respect to a specific context, with respect to a numeric quantity or otherwise quantifiable relationship, e.g., perpendicularity or parallelism, is to be understood as indicating that quantity +−10%. Thus, for example, lines that are substantially perpendicular to one another may be at angles between 81° and 99° to one another. In a further example, dimensions that are substantially between 1 mm and 3 mm, for example, may range from 0.9 mm to 3.3 mm. In another example, an angle that is substantially in the range of 1 to 1.1 radians may be between 0.9 radians and 1.21 radians.

A plug may generally include a handle portion and a plug electrode. In some examples, the number of the plug electrodes may generally be two. In this case, the plug may include a hot (L) pin and a neutral (N) pin. In some other examples, the plug may further include a grounding (G) pin in addition to the hot wire pin and the neutral wire pin, such that the number of the plug electrodes may be increased to three.

In some examples, the plug may be further classified by plugs of various specifications, such as an American-standard plug, a Japanese-standard plug, or a Chinese-standard plug, etc. The plug electrodes (the hot wire pin and the neutral wire pin) of the American-standard plug and the Japanese-standard plug may generally define positioning holes.

After long-term research, inventors of the present disclosure have found that, for safety considerations, existing sockets may generally have a relatively large thickness, which causes the sockets to generally have relatively large volumes. In a case where the thickness of the socket is merely reduced to make the socket thinner, although the volume of the socket may be reduced, the plug electrode of the plug may not be completely inserted into the socket and may be partially exposed in the air. In this case, a risk of electric shock to a user may be increased, and safety hazards may exist. In order to solve the above problem, the present disclosure provides the following embodiments.

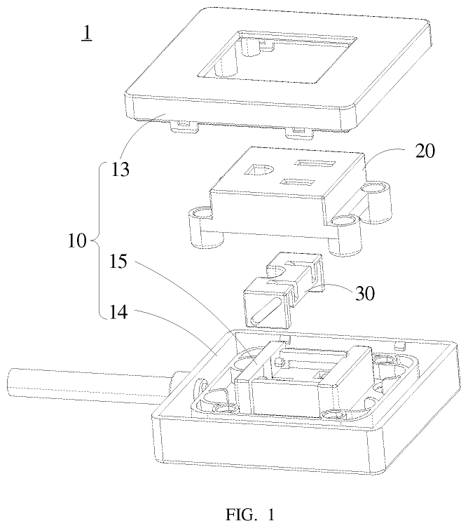

As shown in FIGS. 1-3, a socket 1 may include a socket body 10, a hole member 20, and a linkage mechanism 30. An electrode member 11 may be disposed on the socket body 10. An insertion hole 21 may be defined on the hole member 20. The hole member 20 may be disposed on the socket body 10 so as to be vertically movable relative thereto. The linkage mechanism 30 may be disposed on the socket body 10 and linked with the hole member 20. The linkage mechanism 30 may be configured to be triggered by an insertion of the plug electrode toward the electrode member 11 through the insertion hole 21 along an insertion direction of the plug electrode, so as to drive the hole member 20 to rise relative to the socket body 10 along the insertion direction of the plug electrode.

A lifting direction of the hole member 20 may be substantially parallel to the insertion direction of the plug electrode inserted into the insertion hole 21. The insertion hole 21 may be defined opposite to the electrode member 11, for example, above the electrode member 11. The electrode member 11 may mainly be configured to perform a conductive function. After the plug is inserted into the socket 1, the plug electrode and the electrode member 11 may be electrically connected to each other, so as to enable transmission of electric power. In some other examples, the electrode member 11 may further be referred to as a spring piece or a metal spring piece.

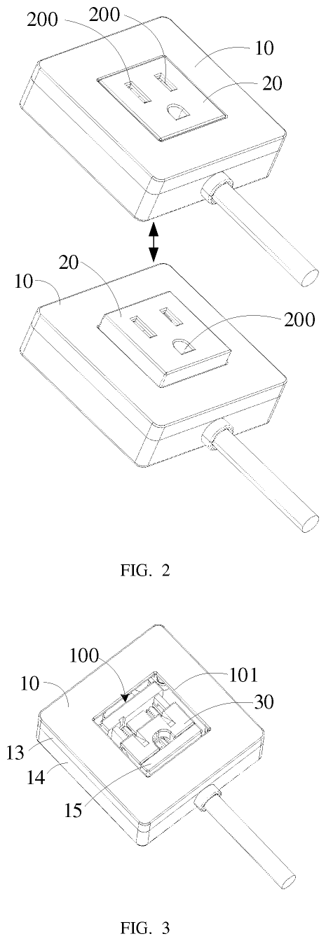

In this case, the hole member 20 may be configured to move up or move down relative to the socket body 10 so as to switch between a storage state and a protruding state. In a case where the hole member 20 is in the storage state, the hole member 20 may be received in the socket body 10 (see FIG. 2), thereby reducing the volume of the socket 1 and making the socket 1 thinner and more compact. In addition, the hole member 20 may be configured to rise during insertion of the plug electrode and switch to the protruding state, such that a portion of the socket 1 may become thicker (see FIG. 2), thereby reducing a risk of the plug electrode being exposed.

In some embodiments, the linkage mechanism 30 may be movably disposed on the socket body 10. The linkage mechanism 30 may be configured to be pushed by the plug electrode during insertion of the plug electrode, so as to drive the hole member 20 to rise relative to the socket body 10 along the insertion direction of the plug electrode. That is, in a case where the plug electrode is inserted, the linkage mechanism 30 may be configured to drive the hole member 20 to rise under the action of the plug electrode. In this case, the hole member 20 may be enabled to promptly switch from the storage state to the protruding state, which reduces a risk that the hole member 20 fails to rise in time and causes the plug electrode to be exposed.

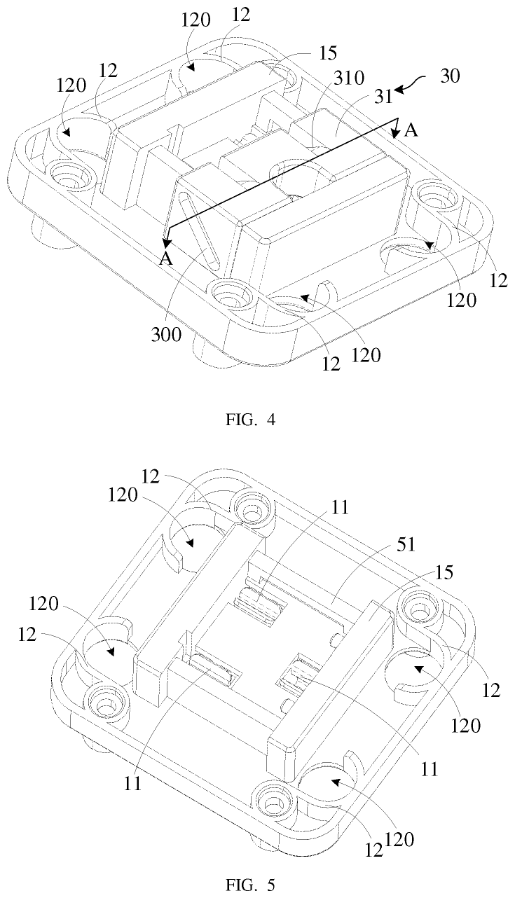

In some embodiments, as shown in FIG. 4 and FIG. 5, the linkage mechanism 30 may include a safety door 31. The safety door 31 may be movably disposed on the socket body 10. The safety door 31 may be linked with or operatively connected to the hole member 20. The safety door 31 may be configured to move relative to the socket body 10 between a first position and a second position. The safety door 31 may be configured to be pushed by the plug electrode during insertion of the plug electrode, so as to move from the first position toward the second position, thereby driving the hole member 20 to rise relative to the socket body 10 along the insertion direction of the plug electrode. In this case, the linkage mechanism 30 may be improved based on the safety door 31, thereby reducing a production cost of the socket 1.

In a case where the safety door is at the first position, the safety door may be configured to at least partially block the electrode member 11. In a case where the safety door is at the second position, the electrode member 11 may be exposed through the insertion hole 21. That is, in a case where the safety door 31 is at the first position, the electrode member 11 may be blocked, thereby reducing a possibility that a child or a pet accidentally touches the electrode member 11 through the insertion hole 21. In a case where the safety door 31 is at the second position, the plug electrode may be inserted into the insertion hole 21 and may be connected to the electrode member 11. The safety door 31 may be located between the socket body 10 and the hole member 20.

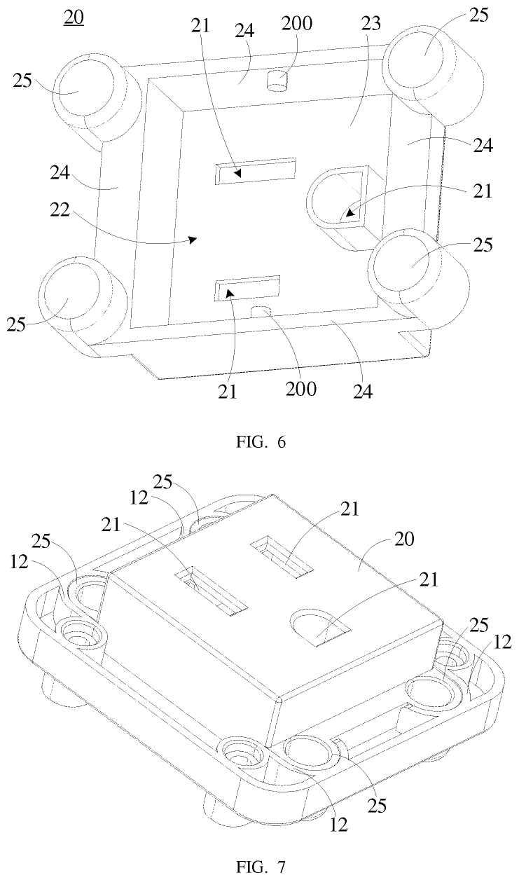

In some embodiments, the safety door 31 may be provided with a first guiding portion 300 (see FIG. 4). A second guiding portion 200 (see FIG. 6) may be disposed on the hole member 20. The first guiding portion 300 and the second guiding portion 200 may be movably connected to each other. The safety door 31 and the hole member 20 may be linked with or operatively connected to each other through the first guiding portion 300 and the second guiding portion 200.

In some embodiments, a relative movement path between the first guiding portion 300 and the second guiding portion 200 may be inclined relative to both the insertion direction of the plug electrode and a movement direction of the safety door 31.

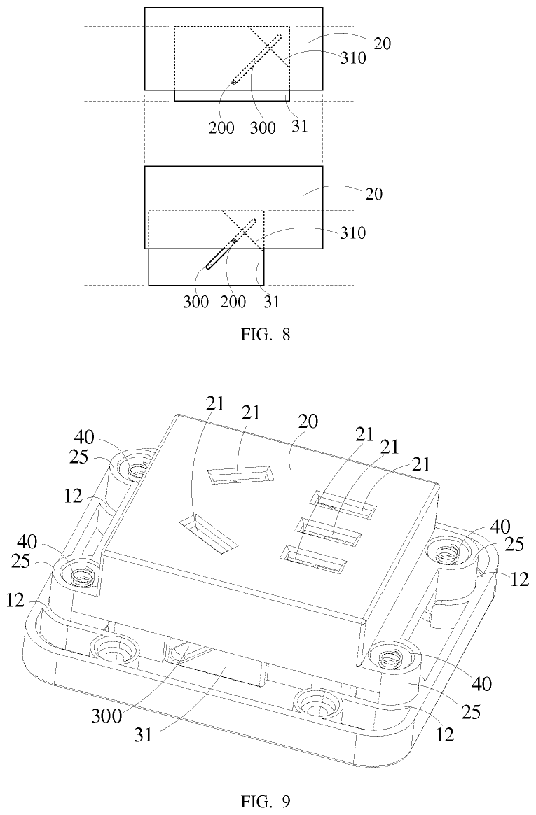

In some embodiments, as shown in FIG. 7 and FIG. 8, the first guiding portion 300 may include a sliding rail. The sliding rail may be disposed on the safety door 31. The second guiding portion 200 may include a sliding block. The sliding block may be disposed on the hole member 20. The sliding block may be slidably disposed on the sliding rail. An extension direction of the sliding rail may be inclined relative to both the movement direction of the safety door 31 and the insertion direction of the plug electrode. The sliding rail may be configured to guide relative sliding of the sliding block, thereby enabling the hole member 20 to move up or move down relative to the socket body 10 along the insertion direction of the plug electrode. The movement direction of the safety door 31 may be substantially perpendicular to the insertion direction of the plug electrode.

In some embodiments, the movement direction of the safety door 31 may substantially be a horizontal direction, and the insertion direction of the plug electrode may substantially be a vertical direction. Further, in a case where the safety door 31 is at the first position, the sliding block may be located on a side of the sliding rail close to a bottom portion (away from the insertion hole 21). In this case, when the safety door 31 moves horizontally under the action of the plug electrode, the sliding rail may be configured to move accordingly. In addition, the extension direction of the sliding rail may be inclined relative to both the insertion direction and the movement direction, which means that the sliding rail may generate an upward component in the extension direction. Thus, during movement of the sliding block relative to the sliding rail, an upward movement component may be generated by the sliding block, thereby enabling the sliding block and the hole member 20 as a whole to move upward relative to the socket body 10.

In some embodiments, the hole member 20 may define an accommodating groove 22 on a side facing the safety door 31. The accommodating groove 22 may be in communication with the insertion hole 21 (see FIG. 6). At least a portion of the safety door 31 may be disposed in the accommodating groove 22. The sliding rail may be disposed on a side wall of the safety door 31. The sliding block may be disposed on a groove wall of the accommodating groove 22. In some embodiments, the sliding rail may be disposed on the side wall. An extension direction of the side wall may be substantially parallel to the movement direction of the safety door 31. Correspondingly, the sliding block may be disposed on the groove wall whose extension direction is substantially parallel to the movement direction of the safety door 31.

In some embodiments, the safety door 31 may include an abutting surface 310 (see FIG. 4). The abutting surface 310 may be inclined relative to the insertion direction of the plug electrode. In a case where the safety door 31 is at the first position, the abutting surface 310 may be located between the insertion hole 21 and the electrode member 11 in the insertion direction of the plug electrode. The abutting surface 310 may be configured to abut against the plug electrode, thereby guiding the plug electrode to slide on the abutting surface 310 so as to push the safety door 31 to move from the first position toward the second position. In this case, after the plug electrode is inserted into the insertion hole 21, the plug electrode may slide along the abutting surface 310 so as to drive the safety door 31 to move from the first position toward the second position.

In some embodiments, the socket body 10 may define an accommodating space 100 and a through hole 101. The through hole 101 may be in communication with the accommodating space 100 (see FIG. 3). The electrode member 11 and the safety door 31 may be disposed in the accommodating space 100. The hole member 20 may be configured to move up or move down relative to the socket body 10 through the through hole 101, so as to switch between the storage state and the protruding state. When in the storage state, the hole member 20 may sink into the through hole 101 or may be substantially flush with a plane where the through hole 101 is located. When in the protruding state, the hole member 20 may partially extend out of the through hole 101.

In some embodiments, the socket body 10 may include an upper shell 13, a lower shell 14, and a fixing frame 15. The fixing frame 15 may be disposed between the upper shell 13 and the lower shell 14 (see FIG. 3). The upper shell 13 and the lower shell 14 may be assembled with each other, so as to define the accommodating space 100. The through hole 101 may be defined on the upper shell 13. The fixing frame 15 may be disposed in the accommodating space 100. The electrode member 11 may be fixedly disposed on the fixing frame 15. The safety door 31 may be slidably disposed on the fixing frame 15. The safety door 31 may be configured to move relative to the fixing frame 15 between the first position and the second position.

In some embodiments, as shown in FIG. 6, the hole member 20 may include a face shell 23 and a side wall 24 connected to the face shell 23. The insertion hole 21 may be defined on the face shell 23. The side wall 24 may be configured to movably pass through the through hole 101. In some embodiments, the socket body 10 may include, at a periphery of the through hole 101, a guiding column 25 extending toward the accommodating space 100 along the insertion direction of the plug electrode. The guiding column 25 may be disposed on one of the hole member 20 and the socket body 10. A positioning portion 12 may be disposed on the other one of the hole member 20 and the socket body 10. The positioning portion 12 may define a positioning groove 120. That is, in some embodiments, the positioning portion 12 may be disposed on the socket body 10 or may be integrally formed with the socket body 10, and the guiding column 25 may be disposed on the hole member 20 or may be integrally formed with the hole member 20. In some other embodiments, the positioning portion 12 may be disposed on the hole member 20 or may be integrally formed with the hole member 20, and the guiding column 25 may be disposed on the socket body 10 or may be integrally formed with the socket body 10.

The guiding column 25 may be movably inserted into the positioning groove 120, so as to guide a movement of the hole member 20 relative to the socket body 10 along the insertion direction of the plug electrode. In this case, a movement range of the hole member 20 may be limited to movement in the vertical direction, thereby reducing a possibility that the hole member 20 moves in the horizontal direction during movement of the safety door 31, and enabling the hole member 20 to promptly rise during movement of the safety door 31 or during insertion of the plug electrode.

In some embodiments, the guiding column 25 may be disposed on the side wall 24 and may be spaced apart from the face shell 23. In a projection direction substantially parallel to the insertion direction of the plug electrode, a projection of the guiding column 25 may be at least partially located outside projections of the face shell 23 and the side wall 24. In this case, the guiding column 25 may further be configured to perform a limiting function. In a case where the hole member 20 rises, a portion of the guiding column 25 located outside the side wall 24 may move to contact the upper shell 13 of the socket body 10, so as to limit the hole member 20 from continuing to move upward.

In some embodiments, the number of the electrode member 11 may be at least two. Each electrode member 11 may include at least one electrode contact portion. The number of the insertion hole 21 may correspondingly be at least two. The at least two insertion holes 21 may respectively correspond one-to-one with the at least two electrode contact portions. The two electrode members 11 may be respectively connected to a hot wire and a neutral wire. In this case, the socket 1 may be configured to receive insertion of a plug having two pins. In a case where the safety door 31 is at the first position, the safety door 31 may block at least part of the electrode contact portions.

In some embodiments, the number of the electrode member 11 may be three (see FIGS. 2-6). Each electrode member 11 may include one electrode contact portion. The number of the insertion hole 21 may be three. The three electrode members 11 may be respectively connected to a hot wire, a neutral wire, and a ground wire. In this case, the socket 1 may be configured to receive insertion of a plug having three pins.

It should be noted that when the number of the electrode member 11 and the number of the insertion hole 21 are changed, a shape of the linkage mechanism and a shape of the face shell may be correspondingly changed.

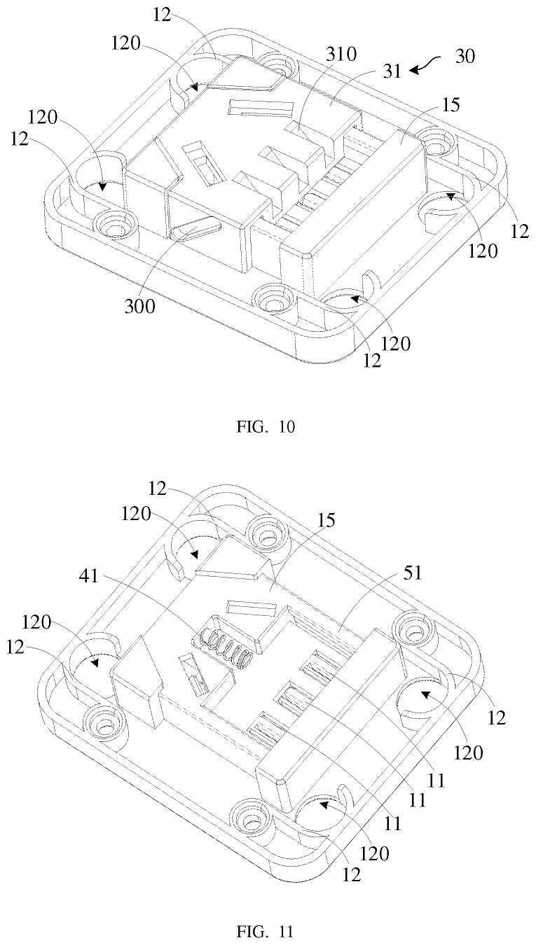

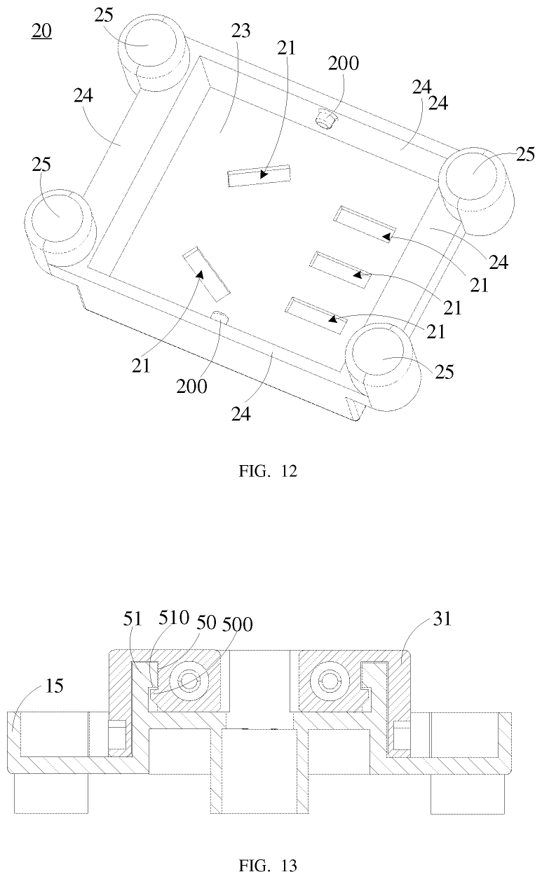

In some embodiments, as shown in FIG. 9, FIG. 10, FIG. 11, and FIG. 12, the number of the electrode member 11 may be three. In this case, two electrode members 11 may each include two electrode contact portions, and the other electrode member 11 may include one electrode contact portion. The electrode members 11 each including two electrode contact portions may be respectively configured to connect a hot wire and a neutral wire. The electrode member 11 including one electrode contact portion may be configured to connect a ground wire. Correspondingly, the number of the insertion hole 21 may be five. In this case, the socket 1 may be configured to receive insertion of a plug having three pins and/or a plug having two pins. An operational principle of the linkage mechanism 30 may refer to the above descriptions and will not be repeated herein.

In some embodiments, as shown in FIG. 9, the socket 1 may further include a first elastic member 40. The first elastic member 40 may be disposed on the socket body 10, so as to drive the hole member 20 to switch from the protruding state to the storage state.

In some embodiments, the first elastic member 40 may be disposed between the guiding column 25 and the socket body 10. The first elastic member 40 may be configured to apply an elastic force to the guiding column 25 toward the positioning groove 120, thereby driving the hole member 20 to move downward relative to the socket body 10. That is, the first elastic member 40 may be deformed to store energy during rising of the hole member 20. In a case where the plug electrode is withdrawn, the first elastic member 40 may elastically return and release energy, so as to drive the hole member 20 to move downward relative to the socket body 10.

In some embodiments, the first elastic member 40 may be elastically connected to a bottom portion of the positioning groove 120 and the guiding column 25. In this case, the first elastic member 40 may be stretched during rising of the hole member 20, and when the plug electrode is withdrawn, the first elastic member 40 may elastically return, so as to drive the hole member 20 to move downward relative to the socket body.

The first elastic member 40 may further be disposed between the guiding column 25 and the upper shell 13 of the socket body 10. An installation groove may be defined on a side of the guiding column 25 facing the upper shell 13. The first elastic member 40 may be disposed in the installation groove. The first elastic member 40 may elastically abut against the upper shell 13. In this case, the first elastic member 40 may be compressed during rising of the hole member 20, and when the plug electrode is withdrawn, the first elastic member 40 may elastically return, so as to drive the hole member 20 to move downward relative to the socket body 10.

In some other examples, the socket 1 may not include the first elastic member 40. In this case, when the plug electrode is inserted into the insertion hole 21, the safety door 31 and the hole member 20 may still be driven to rise. In a case where the plug electrode is withdrawn, a user may manually press the hole member 20 so as to reset the hole member 20.

In some embodiments, a cross-sectional shape of the side wall 24 in a direction substantially perpendicular to the lifting direction of the hole member 20 may match a shape of the through hole 101, such that the through hole 101 may guide relative movement of the side wall 24 in the through hole 101. That is, in some examples, the through hole 101 may be configured to guide relative movement of the hole member 20 relative to the socket body 10 along the insertion direction of the plug electrode. The through hole 101 may be configured to limit movement of the hole member 20 in other directions. In this way, the guiding column 25 and the positioning portion 12 may not be necessary.

In some embodiments, the socket 1 may further include the first elastic member 40. The first elastic member 40 may elastically abut between the hole member 20 and the socket body 10. The first elastic member 40 may be configured to drive the hole member 20 to move downward relative to the socket body 10 along the insertion direction of the plug electrode, thereby driving the safety door 31 to reset from the second position to the first position.

In some embodiments, as shown in FIG. 11, the socket 1 may include a second elastic member 41. The second elastic member 41 may elastically abut between the socket body 10 and the safety door 31. The second elastic member 41 may be configured to drive the safety door 31 to reset from the second position to the first position, thereby driving the hole member 20 to move downward relative to the socket body 10 along the insertion direction of the plug electrode. In this case, when the plug electrode is withdrawn, the second elastic member 41 may release energy, so as to drive the safety door 31 to reset.

In some other embodiments, the socket 1 may not include the second elastic member 41. In this case, since the safety door 31 and the hole member 20 are linked with or operatively connected to each other, when the hole member 20 resets, the safety door 31 may reset accordingly.

In some embodiments, as shown in FIG. 13, one of the fixing frame 15 and the safety door 31 may define a matching groove 50, and the other one of the fixing frame 15 and the safety door 31 may include a matching protrusion 51. The matching protrusion 51 may be slidably disposed in the matching groove 50, such that the safety door 31 may move relative to the fixing frame 15. An extension direction of the matching groove 50 and an extension direction of the matching protrusion 51 may be substantially parallel to the movement direction of the safety door 31.

In some embodiments, as shown in FIG. 13, a first limiting portion 500 may be disposed in the matching groove 50. A second limiting portion 510 may be disposed on the matching protrusion 51. The first limiting portion 500 and the second limiting portion 510 may cooperate to limit separation between the matching groove 50 and the matching protrusion 51. The first limiting portion 500 and the second limiting portion 510 may be elongated. An extension direction of the first limiting portion 500 and an extension direction of the second limiting portion 510 may both be substantially parallel to the movement direction of the safety door 31.

In addition, the hole member 20 may further include a universal serial bus interface (not shown in the drawings). The universal serial bus interface may be spaced apart from the insertion hole 21. The universal serial bus interface may be referred to as a USB interface. The universal serial bus interface may include at least one of a Standard type-A interface, a Mini type-A interface, a Micro type-A interface, a Standard type-B interface, a Mini type-B interface, a Micro type-B interface, or a Type-C interface.

The above description is illustrative and not restrictive. The scope of the disclosure is defined by the appended claims.

1. A socket, comprising:
a socket body, comprising an electrode member;
a hole member, defining an insertion hole and disposed on the socket body so as to be vertically movable relative thereto; and
a linkage mechanism, disposed on the socket body and linked with the hole member, wherein
the linkage mechanism comprises a safety door, the safety door is movably disposed on the socket body and linked with the hole member, the safety door is movable between a first position and a second position;
the safety door is configured to be pushed by a plug electrode during insertion of the plug electrode to move from the first position toward the second position, further driving the hole member to rise relative to the socket body along an insertion direction of the plug electrode; and
wherein when the safety door is at the first position, the safety door is configured to at least partially block the electrode member; and when the safety door is at the second position, the safety door is configured to expose the electrode member through the insertion hole.

2. The socket as claimed in claim 1, wherein
the safety door comprises a first guiding portion, the hole member comprises a second guiding portion, the first guiding portion and the second guiding portion are movably connected to each other, and the safety door and the hole member are operatively connected to each other through the first guiding portion and the second guiding portion.

3. The socket as claimed in claim 2, wherein
a relative movement path between the first guiding portion and the second guiding portion is inclined relative to both the insertion direction of the plug electrode and the movement direction of the safety door.

4. The socket as claimed in claim 2, wherein
the first guiding portion comprises a sliding rail disposed on the safety door, the second guiding portion comprises a sliding block disposed on the hole member, and the sliding block is slidably disposed on the sliding rail;
an extension direction of the sliding rail is inclined relative to both the movement direction of the safety door and the insertion direction of the plug electrode; and
the sliding rail is configured to guide relative sliding of the sliding block, further enabling the hole member to move up or move down relative to the socket body along the insertion direction of the plug electrode.

5. The socket as claimed in claim 4, wherein
a side of the hole member facing the safety door defines an accommodating groove, the accommodating groove is in communication with the insertion hole, the safety door is at least partially disposed in the accommodating groove;
the sliding rail is disposed on a side wall of the safety door, and the sliding block is disposed on a groove wall of the accommodating groove.

6. The socket as claimed in claim 1, wherein
the safety door comprises an abutting surface, and the abutting surface is inclined relative to the insertion direction of the plug electrode;
in a case where the safety door is at the first position, the abutting surface is located between the insertion hole and the electrode member in the insertion direction of the plug electrode, the abutting surface is configured to abut against the plug electrode, further guiding the plug electrode to slide on the abutting surface and pushing the safety door to move from the first position toward the second position.

7. The socket as claimed in claim 1, wherein
the socket body defines an accommodating space and a through hole in communication with the accommodating space, the electrode member and the safety door are disposed in the accommodating space;
the hole member is configured to move up or move down relative to the socket body through the through hole to switch between a storage state and a protruding state; and
in a case where the hole member is in the storage state, the hole member is configured to sink into the through hole or to be substantially flush with a plane where the through hole is located; and
in a case where the hole member is in the protruding state, the hole member is configured to partially extend out of the through hole.

8. The socket as claimed in claim 7, wherein
the hole member comprises a face shell and a side wall connected to the face shell, the insertion hole is defined on the face shell, and the side wall is movably disposed through the through hole;
one of the hole member and the socket body comprises a guiding column, the other one of the hole member and the socket body comprises a positioning portion, and the positioning portion defines a positioning groove;
an extension direction of the guiding column and an extension direction of the positioning groove are substantially parallel to the insertion direction of the plug electrode, the guiding column is movably inserted into the positioning groove, guiding relative movement of the hole member relative to the socket body along the insertion direction of the plug electrode.

9. The socket as claimed in claim 8, wherein the guiding column is disposed on the side wall and is spaced apart from the face shell;
in a projection direction substantially parallel to the insertion direction of the plug electrode, a projection of the guiding column is at least partially located outside projections of the face shell and the side wall.

10. The socket as claimed in claim 8, further comprising:
a first elastic member, disposed on the socket body and configured to drive the hole member to switch from the protruding state to the storage state.

11. The socket as claimed in claim 10, wherein
the first elastic member is disposed between the guiding column and the socket body, and the first elastic member is configured to apply an elastic force to the guiding column toward the positioning groove, driving the hole member to move downward relative to the socket body; and/or
a shape of the side wall substantially matches a shape of the through hole, enabling the through hole to be configured to guide relative movement of the side wall in the through hole.

12. The socket as claimed in claim 7, wherein
the socket body comprises an upper shell, a lower shell, and a fixing frame disposed between the upper shell and the lower shell;
the upper shell and the lower shell are assembled with each other to define the accommodating space, the through hole is defined on the upper shell, the fixing frame is disposed in the accommodating space, the electrode member is fixedly disposed on the fixing frame, and the safety door is slidably disposed on the fixing frame and movable relative to the fixing frame between the first position and the second position.

13. The socket as claimed in claim 12, wherein one of the fixing frame and the safety door defines a matching groove, and the other one of the fixing frame and the safety door comprises a matching protrusion;
the matching protrusion is slidably disposed in the matching groove, enabling the safety door to move relative to the fixing frame, and an extension direction of the matching groove and an extension direction of the matching protrusion are substantially parallel to the movement direction of the safety door.

14. The socket as claimed in claim 13, wherein a first limiting portion is disposed in the matching groove, a second limiting portion is disposed on the matching protrusion, the first limiting portion and the second limiting portion cooperate to limit separation between the matching groove and the matching protrusion.

15. The socket as claimed in claim 14, wherein the first limiting portion and the second limiting portion are elongated, and an extension direction of the first limiting portion and an extension direction of the second limiting portion are both substantially parallel to the movement direction of the safety door.

16. The socket as claimed in claim 1, further comprising:
a first elastic member, elastically abutting between the hole member and the socket body, and configured to drive the hole member to move downward relative to the socket body along the insertion direction of the plug electrode, further driving the safety door to reset from the second position to the first position; and
a second elastic member, elastically abutting between the socket body and the safety door, and configured to drive the safety door to reset from the second position to the first position, further driving the hole member to move downward relative to the socket body along the insertion direction of the plug electrode.

17. The socket as claimed in claim 1, wherein
the number of the electrode member is at least two, each of the electrode members comprises at least one electrode contact portion, the number of the insertion hole is correspondingly at least two, the at least two insertion holes respectively correspond one-to-one with the at least two electrode contact portions, and in a case where the safety door is at the first position, the safety door is configured to at least partially block the electrode contact portions.

18. The socket as claimed in claim 1, wherein
the number of the electrode member is three, each of the electrode members comprises one electrode contact portion, and the number of the insertion hole is three.

19. The socket as claimed in claim 1, wherein
the number of the electrode member is three, two of the three electrode members each comprise two electrode contact portions, the other one of the three electrode members comprises one electrode contact portion, and the number of the insertion hole is five.

20. The socket as claimed in claim 10, further comprising:
a first elastic member, disposed between the guiding column and an upper shell of the socket body, wherein an installation groove is defined on a side of the guiding column facing the upper shell, the first elastic member is disposed in the installation groove, and the first elastic member is configured to elastically abut against the upper shell.
